(19) United States
(12) Patent Application Publication
(10) Pub. No.: US 2024/0401941 A1
(43) Pub. Date: Dec. 5, 2024

(54) POWER-EFFICIENT, PERFORMANCE-EFFICIENT, AND CONTEXT-ADAPTIVE POSE TRACKING

(71) Applicant: QUALCOMM Incorporated, San Diego, CA (US)

(72) Inventors: Nisarg Keyurbhai TRIVEDI, Santa Clara, CA (US); Diyan TENG, Sunnyvale, CA (US); Junsheng HAN, Los Altos Hills, CA (US); Victor KULIK, San Jose, CA (US); Rashmi KULKARNI, Redwood City, CA (US)

(21) Appl. No.: 18/325,752

(22) Filed: May 30, 2023

(51) Int. Cl. G01B 21/00

(52) U.S. Cl. CPC G01B 21/00

(57) ABSTRACT

In some aspects, a pose tracking device may receive usability information from a sensor system that includes a plurality of sensors based on current operating conditions associated with the plurality of sensors. The pose tracking device may select a set of sensor modalities associated with the sensor system based on the usability information. The pose tracking device may select a pose tracking model based on the set of sensor modalities selected and one or more key performance indicator (KPI) requirements related to a current context associated with a pose tracking configuration for a client application. The pose tracking device may estimate a pose associated with an object using the pose tracking model based on sensor inputs associated with the one or more sensors selected from the plurality of sensors. Numerous other aspects are described.

### FIELD OF THE DISCLOSURE

Aspects of the present disclosure generally relate to pose estimation and, for example, to a pose tracking device that may perform power-efficient, performance-efficient, and context-adaptive pose tracking.

### BACKGROUND

“Pose tracking,” also known as pose estimation, refers to techniques that are used to infer or estimate the position and/or orientation of a device, a person, or an object in three-dimensional space relative to a given reference frame. Pose tracking may generally refer to techniques that are used to estimate a position and/or an orientation associated with a tracked object (e.g., a user, a user device, or a physical real-world object) over one or more axes (e.g., with three degrees of freedom (3DoF) over three positional axes or three orientation axes, or with six degrees of freedom (6DoF) over three positional axes and three orientation axes). Additionally, or alternatively, pose tracking may include techniques to estimate one or more velocities of a tracked object, such as an absolute or relative linear velocity or an absolute or relative angular velocity of the tracked object. In general, pose tracking is performed by analyzing signals from different sensor inputs (e.g., images or videos captured by one or more cameras, position coordinates obtained from one or more satellite navigation systems, or the like), to determine the position and/or orientation of an object of interest.

### SUMMARY

Some aspects described herein relate to a method for power-efficient and performance-efficient context-adaptive pose tracking. The method may include receiving, by a pose tracking device, information that includes one or more key performance indicator (KPI) requirements related to a current context associated with a pose tracking configuration for a client application. The method may include receiving, by the pose tracking device, usability information from a sensor system that includes a plurality of sensors based on one or more parameters related to current operating conditions associated with the plurality of sensors. The method may include selecting, by the pose tracking device, a set of sensor modalities that includes one or more sensors from the plurality of sensors included in the sensor system based on the current context associated with the pose tracking configuration for the client application and the usability information related to the current operating conditions associated with the plurality of sensors. The method may include selecting, by the pose tracking device, a pose tracking model based on the set of sensor modalities and the one or more KPI requirements related to the current context associated with the pose tracking configuration for the client application. The method may include estimating, by the pose tracking device, a pose associated with a tracked object using the pose tracking model based on sensor inputs associated with the set of sensor modalities.

Some aspects described herein relate to a pose tracking device for power-efficient and performance-efficient context-adaptive pose tracking. The pose tracking device may include one or more memories and one or more processors coupled to the one or more memories. The one or more processors may be configured to receive information that includes one or more KPI requirements related to a current context associated with a pose tracking configuration for a client application. The one or more processors may be configured to receive usability information from a sensor system that includes a plurality of sensors based on one or more parameters related to current operating conditions associated with the plurality of sensors. The one or more processors may be configured to select a set of sensor modalities that includes one or more sensors from the plurality of sensors included in the sensor system based on the current context associated with the pose tracking configuration for the client application and the usability information related to the current operating conditions associated with the plurality of sensors. The one or more processors may be configured to select a pose tracking model based on the set of sensor modalities and the one or more KPI requirements related to the current context associated with the pose tracking configuration for the client application. The one or more processors may be configured to estimate a pose associated with a tracked object using the pose tracking model based on sensor inputs associated with the set of sensor modalities.

Some aspects described herein relate to a non-transitory computer-readable medium that stores a set of instructions for power-efficient and performance-efficient context-adaptive pose tracking by a pose tracking device. The set of instructions, when executed by one or more processors of the pose tracking device, may cause the pose tracking device to receive information that includes one or more KPI requirements related to a current context associated with a pose tracking configuration for a client application. The set of instructions, when executed by one or more processors of the pose tracking device, may cause the pose tracking device to receive usability information from a sensor system that includes a plurality of sensors based on one or more parameters related to current operating conditions associated with the plurality of sensors. The set of instructions, when executed by one or more processors of the pose tracking device, may cause the pose tracking device to select a set of sensor modalities that includes one or more sensors from the plurality of sensors included in the sensor system based on the current context associated with the pose tracking configuration for the client application and the usability information related to the current operating conditions associated with the plurality of sensors. The set of instructions, when executed by one or more processors of the pose tracking device, may cause the pose tracking device to select a pose tracking model based on the set of sensor modalities and the one or more KPI requirements related to the current context associated with the pose tracking configuration for the client application. The set of instructions, when executed by one or more processors of the pose tracking device, may cause the pose tracking device to estimate a pose associated with a tracked object using the pose tracking model based on sensor inputs associated with the set of sensor modalities.

Some aspects described herein relate to an apparatus for power-efficient and performance-efficient context-adaptive pose tracking. The apparatus may include means for receiving information that includes one or more KPI requirements related to a current context associated with a pose tracking configuration for a client application. The apparatus may include means for receiving usability information from a sensor system that includes a plurality of sensors based on one or more parameters related to current operating conditions associated with the plurality of sensors. The apparatus may include means for selecting a set of sensor modalities that includes one or more sensors from the plurality of sensors included in the sensor system based on the current context associated with the pose tracking configuration for the client application and the usability information related to the current operating conditions associated with the plurality of sensors. The apparatus may include means for selecting a pose tracking model based on the set of sensor modalities and the one or more KPI requirements related to the current context associated with the pose tracking configuration for the client application. The apparatus may include means for estimating a pose associated with a tracked object using the pose tracking model based on sensor inputs associated with the set of sensor modalities.

Aspects generally include a method, apparatus, system, computer program product, non-transitory computer-readable medium, user device, user equipment, electronic device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which power-efficient, performance-efficient, and context-adaptive pose tracking described herein may be implemented, in accordance with the present disclosure.

FIG. 2 is a diagram illustrating example components of a device.

FIG. 3 is a diagram illustrating an example associated with power-efficient, performance-efficient, and context-adaptive pose tracking, in accordance with the present disclosure.

FIG. 4 is a flowchart illustrating an example process associated with power-efficient, performance-efficient, and context-adaptive pose tracking, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Accurate pose tracking is a challenging problem that has various applications, including smartphone tracking, wearable device tracking, unmanned aerial vehicle tracking, autonomous vehicle tracking, extended reality (XR) applications, and/or package tracking, among other examples. For example, as described herein, “pose tracking” may generally refer to techniques that are used to estimate a position and/or an orientation associated with a tracked object (e.g., a user, a user device, or a physical real-world object) over one or more axes (e.g., with three degrees of freedom (3DoF) over three positional axes or three orientation axes, or with six degrees of freedom (6DoF) over three positional axes and three orientation axes), and a pose tracking device is any suitable device that may track a pose (e.g., a position and/or orientation) associated with a tracked object. Existing pose tracking solutions suffer from various drawbacks, however, such as being tailored to a set of available sensors, use cases, and/or power specifications.

For example, existing pose tracking solutions typically estimate a pose according to a set of available sensors, which may be untrustworthy or unreliable under certain conditions. In particular, different sensors may be calibrated to obtain accurate information in certain operating conditions, and may therefore inject spurious signals that cause inaccurate outputs outside the calibrated operating conditions. For example, virtual reality (VR) headsets often use visual-inertial odometry (VIO) supported by high-power cameras, which may not work well in cases where insufficient light and/or insufficient features are present in a scene. In other examples, an ambient light sensor (ALS) may be unable to generate an accurate sensor input when a device incorporating the ALS is in a user's pocket, and a global navigation satellite system (GNSS) receiver may be unable to generate an accurate sensor input when the GNSS receiver is indoors. Furthermore, another drawback associated with existing pose tracking solutions is that the same model is often used for each iteration of a given pose estimation task, although the model that is best suited to the pose estimation task may depend on operating conditions. For example, the model best suited to a given pose estimation task may change when there is a change to a KPI, such as a client demand, battery level, sensor usability, model confidence, and/or model power consumption. Accordingly, using the same model every time that a given pose estimation task is performed may result in inaccurate outputs, excess resource consumption, excess power consumption, and/or inaccurate outputs in some cases.

In addition, existing pose tracking solutions may utilize available hardware resources in a suboptimal manner. For example, relative to a battery-powered device, available processor resources for a device that is always plugged-in (e.g., has a wall power source) may include a fast and/or powerful graphics processing unit (GPU) or neural processing unit (NPU). However, a pose tracking model may be configured to use a standard central processing unit (CPU) instead, which may result in the pose tracking model providing a high-latency output and/or preventing other high-priority applications from running on the CPU. In another example, a wearable device typically has a low-power island and a low-power processor to conserve power, but the pose tracking model used on the wearable device may use a standard CPU instead, which may drain a battery in a short time period. Furthermore, in addition to using available hardware resources in a suboptimal manner, existing pose tracking solutions may provide a suboptimal tradeoff between performance and power over time. For example, a pose tracking device may continue to run a pose tracking model even after the pose tracking model starts to generate outlier outputs, low confidence outputs, saturated performance metrics, and/or high power consumption, which may result in inaccurate outputs, battery drain, and/or other performance and/or power consumption problems.

Some aspects described herein enable power-efficient, performance-efficient, and context-adaptive pose tracking, which may provide a universal pose tracking solution that can use multiple combinations of sensor modalities across different device form factors based on various criteria, such as a desired accuracy, sensor usability, power constraints, and/or a current context (e.g., current device type, current device location, current motion detection state, current activity recognition state, and/or current device placement). For example, in some aspects, a pose tracking device may be configured to read a client application configuration and one or more key performance indicator (KPI) requirements (e.g., requirements related to a battery level, processor capabilities, available memory, latency, and/or accuracy), and may adapt to different sensor contexts (e.g., device types, device form factors, location, position, and/or user activity, among other examples). Accordingly, the pose tracking device may select a set of sensor modalities and/or a pose tracking model to optimally balance performance requirements and power consumption requirements. Furthermore, in some aspects, the pose tracking device may optimize pose estimation through intelligent sensor selection, model selection, and hardware reconfiguration based on feedback associated with a model output, which may be continuously monitored to improve performance with respect to varying client requirements. In this way, some aspects described herein may enable intelligent, power-efficient, performance-efficient, and context-adaptive pose tracking that leverages different sensing modalities for various environments, sensor systems, device form factors, user activities, power levels, available hardware resources, and/or client requirements.

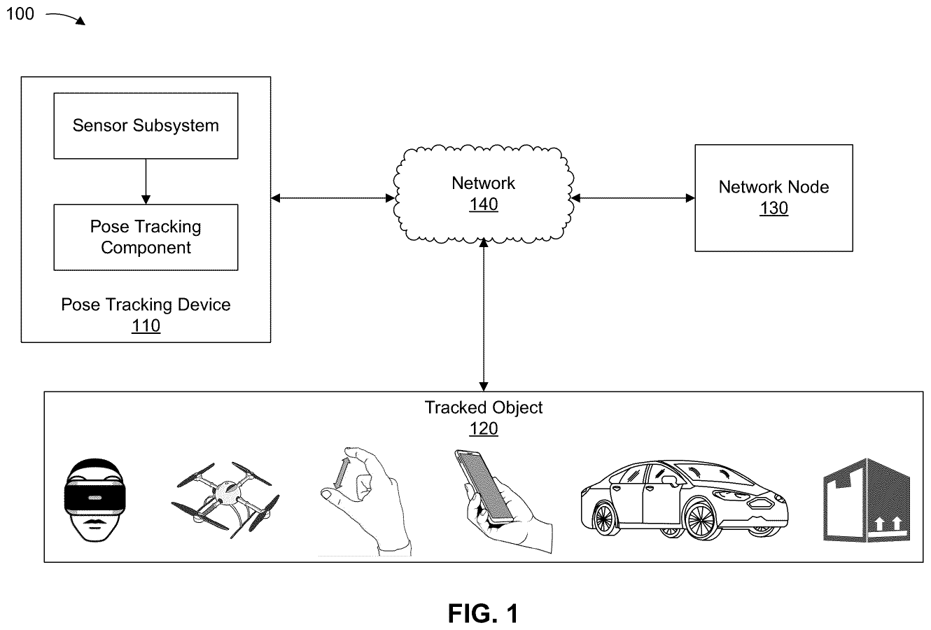

FIG. 1 is a diagram illustrating an example environment 100 in which power-efficient, performance-efficient, and context-adaptive pose tracking described herein may be implemented, in accordance with the present disclosure. As shown in FIG. 1, the environment 100 may include a pose tracking device 110, a tracked object 120, a network node 130, and a network 140. Devices of the environment 100 may interconnect via wired connections, wireless connections, or a combination of wired and wireless connections.

The pose tracking device 110 includes one or more devices capable of receiving, generating, storing, processing, and/or providing information related to an estimated pose associated with the tracked object 120, an estimated velocity associated with the tracked object 120, and/or one or more estimated calibration parameters. For example, as shown in FIG. 1, the pose tracking device 110 may include a sensor subsystem and a pose tracking component that may be configured to estimate the pose associated with the tracked object using a pose tracking model based on sensor inputs associated with a selected set of sensor modalities. For example, in some aspects, the estimated pose of the tracked object 120 may include an estimated position and/or an estimated orientation associated with the tracked object 120, such as an absolute position on one or more axes at a specific time, a relative position (e.g., a displacement) for a time duration on one or more axes, an absolute orientation on one or more axes at a specific time, and/or a relative orientation (e.g., a change in orientation) for a time duration on one or more axes. Additionally, or alternatively, the pose tracking component may be configured to estimate one or more velocities of the tracked object 120, such as an absolute or relative linear velocity or an absolute or relative angular velocity. Additionally, or alternatively, the pose tracking component may estimate one or more parameters to calibrate the sensor subsystem (e.g., based on sensor biases, sensor sensitivities, and/or drift over time or temperature, among other examples).

In some aspects, the pose tracking device 110 may include a wired and/or wireless communication and/or computing device, such as a user equipment (UE), a mobile phone (e. g., a smart phone, a radiotelephone, and/or the like), a laptop computer, a tablet computer, a handheld computer, a desktop computer, a gaming device, a wearable communication device (e.g., a smart wristwatch, a pair of smart eyeglasses, and/or the like), or the like. Furthermore, the tracked object 120 may include a person or part of a person, a user device, or a physical object whose pose and/or motion may be tracked by the pose tracking device 110. For example, in some aspects, the tracked object 120 may include one or more body parts of a user, a VR or XR headset, an unmanned aerial vehicle, a user device, a vehicle, and/or a physical object such as a package, among other examples. In some aspects, the pose tracking device 110 may be included in the tracked object 120 (e.g., where the tracked object 120 is an XR headset or unmanned aerial vehicle with built-in pose tracking capabilities). Additionally, or alternatively, the pose tracking device 110 may be separate from the tracked object 120 (e.g., where the tracked object 120 is a user or one or more body parts of the user, a physical object to be tracked, or a device that is otherwise separate from the pose tracking device 110, such as handheld controllers that are tracked by an XR headset).

Similar to the pose tracking device 110, the network node 130 includes one or more devices capable of receiving, generating, storing, processing, and/or providing information related to an estimated pose associated with the tracked object 120, an estimated velocity associated with the tracked object 120, and/or one or more estimated calibration parameters. For example, the network node 130 may include a base station (a Node B, a gNB, and/or a 5G node B (NB), among other examples), a UE, a relay device, a network controller, an access point, a transmit receive point (TRP), an apparatus, a device, a computing system, one or more components of any of these, and/or another processing entity configured to perform one or more aspects of the techniques described herein (e.g., the pose tracking device 110 may send one or more sensor inputs and/or other suitable information to the network node 130, which may process sensor inputs and/or other suitable information using a pose tracking model and return one or more outputs to the pose tracking device 110). In some aspects, the network node 130 may be an aggregated base station and/or one or more components of a disaggregated base station (e.g., a central unit, a distributed unit, and/or a radio unit).

The network 140 includes one or more wired and/or wireless networks. For example, the network 140 may include a cellular network (e.g., a Long-Term Evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

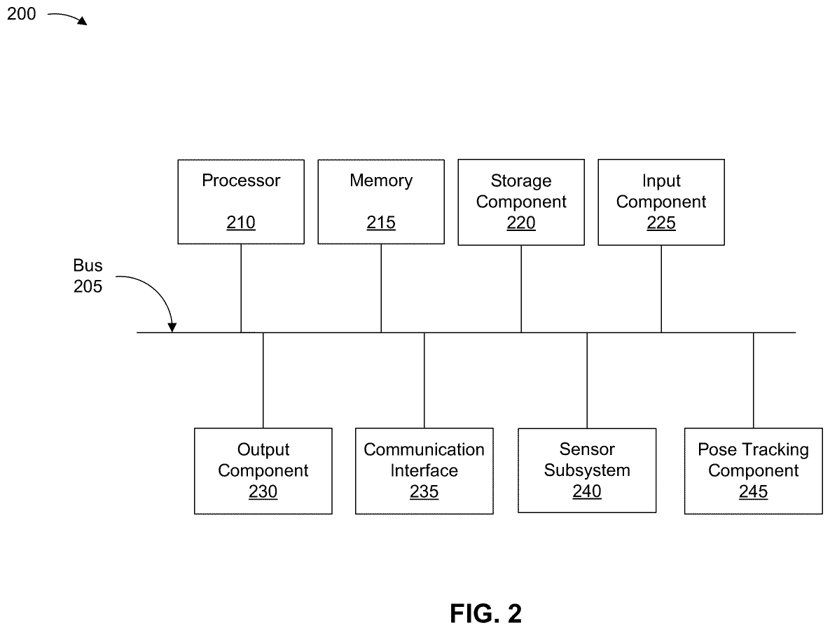

FIG. 2 is a diagram illustrating example components of a device 200, in accordance with the present disclosure. The device 200 may correspond to the pose tracking device 110, the tracked object 120, and/or the network node 130. In some aspects, the pose tracking device 110, the tracked object 120, and/or the network node 130 may include one or more devices 200 and/or one or more components of the device 200. As shown in FIG. 2, device 200 may include a bus 205, a processor 210, a memory 215, a storage component 220, an input component 225, an output component 230, a communication interface 235, a sensor subsystem 240, and/or a pose tracking component 245.

Bus 205 includes a component that permits communication among the components of device 200. Processor 210 is implemented in hardware, firmware, or a combination of hardware and software. Processor 210 is a CPU, a GPU, an NPU, an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 includes one or more processors capable of being programmed to perform a function. Memory 215 includes a random access memory (RAM), a read only memory (ROM), and/or another type of dynamic or static storage device (e.g., a flash memory, a magnetic memory, and/or an optical memory) that stores information and/or instructions for use by processor 210.

Storage component 220 stores information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 includes a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a GNSS component) and/or a sensor for sensing information (e.g., an accelerometer, a gyroscope, an actuator, or another type of position or environment sensor). Output component 230 includes a component that provides output information from device 200 (e.g., a display, a speaker, a haptic feedback component, and/or an audio or visual indicator).

Communication interface 235 includes a transceiver-like component (e.g., a transceiver and/or a separate receiver and transmitter) that enables device 200 to communicate with other devices, such as via a wired connection, a wireless connection, or a combination of wired and wireless connections. Communication interface 235 may permit device 200 to receive information from another device and/or provide information to another device. For example, communication interface 235 may include an Ethernet interface, an optical interface, a coaxial interface, an infrared interface, a radio frequency interface, a universal serial bus (USB) interface, a wireless local area interface (e.g., a Wi-Fi or wireless local area network (WLAN) interface), and/or a cellular network interface.

The sensor subsystem 240 includes one or more wired or wireless devices capable of receiving, generating, storing, processing, and/or providing information related to an estimated pose associated with a tracked object, an estimated velocity associated with a tracked object, and/or one or more estimated calibration parameters for estimating the pose and/or velocity associated with a tracked object, as described elsewhere herein. For example, the sensor subsystem 240 may include an always-on camera, a high-resolution camera, a motion sensor, an accelerometer, a gyroscope, a proximity sensor, a light sensor (e.g., an ALS), a noise sensor, a pressure sensor, an ultrasonic (or ultrasound) sensor, a positioning (e.g., GNSS) sensor, a time-of-flight (ToF) sensor, a radio frequency (RF) sensor (e.g., to detect millimeter wave, WLAN, Bluetooth, and/or other wireless signals), a capacitive sensor, a timing device, an infrared sensor, an active sensor (e.g., a sensor that requires an external power signal), a passive sensor (e.g., a sensor that does not require an external power signal), a biological or biometric sensor, a smoke sensor, a gas sensor, a chemical sensor, an alcohol sensor, a temperature sensor, a moisture sensor, a humidity sensor, a magnetometer, an electromagnetic sensor, an analog sensor, and/or a digital sensor, among other examples. In some aspects, the sensor subsystem 240 may sense or detect a condition or information related to a state of the device 200, an environment surrounding the device 200, and/or an object present in the environment surrounding the device 200 and may send, using a wired or wireless communication interface, an indication of the detected condition or information to other components of the device 200 and/or other devices.

The pose tracking component 245 includes one or more devices capable of receiving, generating, storing, transmitting, processing, detecting, and/or providing estimated pose information, estimated motion information, and/or estimated calibration parameters using a pose tracking model based on one or more sensor inputs, as described elsewhere herein. For example, in some aspects, the pose tracking component 245 may receive information that includes one or more KPI requirements related to a current context associated with a pose tracking configuration for a client application; receive usability information from a sensor system that includes a plurality of sensors based on one or more parameters related to current operating conditions associated with the plurality of sensors; select a set of sensor modalities that includes one or more sensors from the plurality of sensors included in the sensor system based on the current context associated with the pose tracking configuration for the client application and the usability information related to the current operating conditions associated with the plurality of sensors; select a pose tracking model based on the set of sensor modalities and the one or more KPI requirements related to the current context associated with the pose tracking configuration for the client application; and estimate a pose associated with a tracked object using the pose tracking model based on sensor inputs associated with the set of sensor modalities. Additionally, or alternatively, the pose tracking component 245 may perform one or more other operations described herein.

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication interface 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

In some aspects, device 200 includes means for performing one or more processes described herein and/or means for performing one or more operations of one or more processes described herein. For example, device 200 may include means for receiving information that includes one or more KPI requirements related to a current context associated with a pose tracking configuration for a client application; means for receiving usability information from a sensor system that includes a plurality of sensors based on one or more parameters related to current operating conditions associated with the plurality of sensors; means for selecting a set of sensor modalities that includes one or more sensors from the plurality of sensors included in the sensor system based on the current context associated with the pose tracking configuration for the client application and the usability information related to the current operating conditions associated with the plurality of sensors; means for selecting a pose tracking model based on the set of sensor modalities and the one or more KPI requirements related to the current context associated with the pose tracking configuration for the client application; and/or means for estimating a pose associated with a tracked object using the pose tracking model based on sensor inputs associated with the set of sensor modalities. In some aspects, such means may include one or more components of device 200 described in connection with FIG. 2, such as bus 205, processor 210, memory 215, storage component 220, input component 225, output component 230, communication interface 235, sensor subsystem 240, and/or pose tracking component 245.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

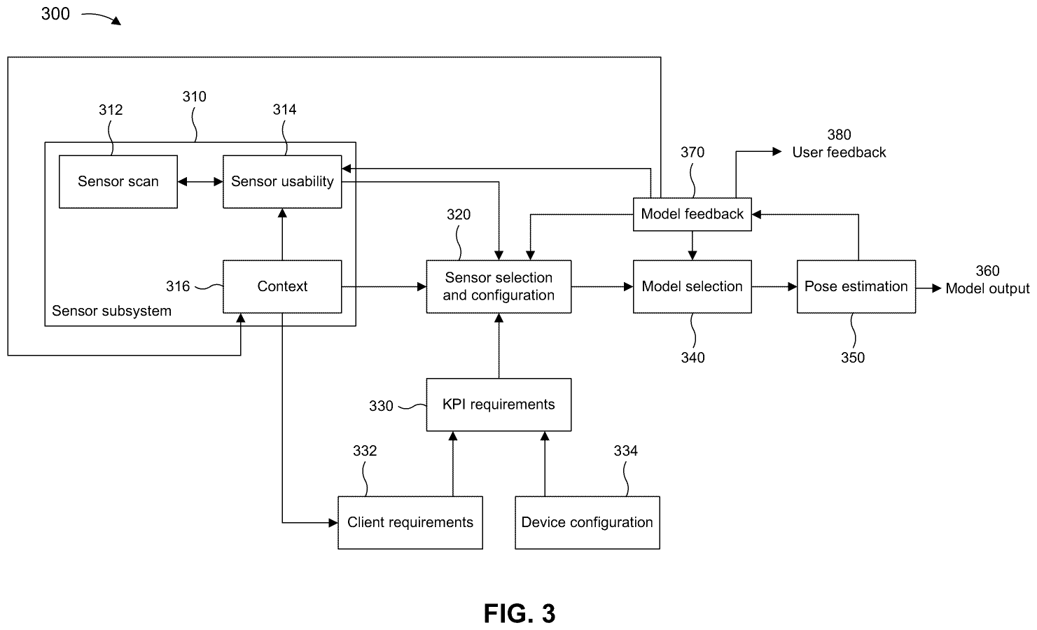

FIG. 3 is a diagram of an example implementation 300 associated with power-efficient, performance-efficient, and context-adaptive pose tracking, in accordance with the present disclosure. As shown in FIG. 3, example implementation 300 includes one or more components associated with a pose tracking device, such as a sensor subsystem 310, a sensor selection and configuration component 320 that may select one or more sensor modalities and/or determine one or more parameters to configure a model selection component 340, and a pose estimation component 350 that may generate a model output 360 and model feedback 370. In some aspects, as described in further detail herein, the various components shown in FIG. 3 may enable power-efficient, performance-efficient, and context-adaptive pose tracking, which may provide a universal pose tracking solution that can use multiple combinations of sensor modalities across different device form factors based on various criteria, such as a desired accuracy, sensor usability, power constraints, and/or a current context.

As shown in FIG. 3, the sensor subsystem 310 may include a sensor scan component 312 that may scan the sensor subsystem 310 to identify a plurality of sensors that are available in or otherwise associated with the sensor subsystem 310. In some aspects, the sensors that are identified using the sensor scan component 312 may include any suitable sensor that can detect a condition or information related to a pose or a motion state associated with a tracked object. For example, in some aspects, the identified sensors may include an always-on camera, a high-resolution camera, a positioning sensor (e.g., a GNSS receiver), an accelerometer, a gyroscope, a pressure sensor, a magnetometer, an ultrasound sensor, a ToF sensor, a proximity sensor, a millimeter wave sensor, a Wi-Fi (or WLAN) sensor, a Bluetooth (or wireless personal area network (WPAN)) sensor, a temperature sensor, an ambient light sensor, and/or other suitable sensors. However, as described above, certain sensors may be designed or calibrated to generate trustworthy or reliable sensor information in certain operating conditions, and may therefore be susceptible of consuming very high power or injecting spurious signals that may cause the pose tracking device to produce inaccurate pose estimates outside the operating conditions for which the sensors are designed or calibrated.

Accordingly, in some aspects, the sensor subsystem 310 may include a sensor usability component 314 that may use information related to a current context 316 to detect the trustworthiness and/or reliability of each available sensor and generate usability information (e.g., a usability score or other suitable information) to indicate the trustworthiness and/or reliability of each available sensor. For example, in some aspects, the current context 316 may include one or more parameters that relate to the current operating conditions for the available sensors, such as a device type associated with the available sensors (e.g., indicating whether each sensor is included in a wearable device, an XR headset, a smartphone, a tracker device, or the like). Additionally, or alternatively, the current operating conditions for the available sensors may relate to a location of the sensor (e.g., indicating whether the sensor is located indoors or outdoors), a motion state associated with the tracked object (e.g., indicating whether a suitable motion, such as a stationary, moving, or other suitable motion characteristic, is detected for each tracked object), a user activity state (e.g., indicating whether each tracked object is associated with a motion state indicative of a user sitting, walking, running, biking, driving, or the like), and/or a device placement (e.g., indicating whether each tracked object is in on a user's body, such as in the user's pocket or in the user's hand, or off a user's body, such as in a car mount or sitting on a desk).

Accordingly, as described herein, the sensor usability component 314 may use the information related to the current context 316 to generate usability information (e.g., a usability score or other suitable information) that indicates the trustworthiness and/or reliability of each available sensor identified by the sensor scan component 312. For example, in a scenario where a client application requests pose tracking while a user is biking outdoors with a smartphone in their pocket, the current context 316 may include information such as a device type (e.g., smartphone, smart watch, earbuds, or the like), a user activity state (e.g., biking, running, walking, or the like), a device placement state (e.g., on user, away from user, in pant-pockets, in hands, or the like), or a device location (e.g., indoors, outdoors, land, sea, or air) associated with the sensors. In this example, the placement in the user's pocket may result in the cameras and ToF sensors providing sensor information that is less useful to pose estimation relative to other sensors, such as inertial sensors and/or a GNSS receiver, whereby the sensor usability component 314 may generate a high usability score for the inertial sensors and/or GNSS receiver and a low usability score for the cameras and/or ToF sensors (e.g., because the GNSS receiver requires satellite availability to generate reliable sensor input, which is available in the current context 316, and the cameras require sufficient lighting, sufficient features, and less occlusion to generate reliable sensor input, which is unavailable in the current context 316). In another example, in a scenario where a client application requests pose tracking while a user is walking in an indoor garage with a smartphone in their hand and a camera-facing motion is detected, the current context 316 may include information such as a device type (e.g., smartphone), a current user activity state (e.g., walking), a device placement state (e.g., the user's hand), and a device location (e.g., indoors). In this example, the indoor location may result in the GNSS receiver providing sensor information that is less useful to pose estimation relative to other sensors, such as cameras and/or ToF sensors, whereby the sensor usability component 314 may generate a high usability score for the cameras and/or ToF sensors and a low usability score for the GNSS receiver.

As further shown in FIG. 3, the usability information generated by the sensor usability component 314 may be provided to the sensor selection and configuration component 320, which may select a set of sensor modalities based on the usability information and one or more KPI requirements 330 related to a current context associated with a pose tracking configuration for a client application. For example, in some aspects, the one or more KPI requirements 330 may include a power constraint and/or an accuracy requirement associated with the pose tracking configuration, where the power constraint and/or accuracy requirement may be based on one or more client requirements 332 and/or one or more parameters related to a device configuration 334. For example, in some aspects, the one or more client requirements may indicate the accuracy requirement, a power requirement (e.g., a required battery level or wall-plugged power source), a processor requirement (e.g., required CPU, GPU, or NPU resources), a memory requirement (e.g., required RAM or available disk storage), a latency requirement, and/or other parameters that relate to a pose or velocity estimate requested by a client application. Furthermore, in some aspects, the client requirements 332 may be further based on the context 316 that relates to a current device type, device location, current motion state, current user activity state, and/or device placement. In addition, the device configuration 334 may provide one or more parameters that relate to available hardware resources that can be used to generate the pose or velocity estimate associated with a tracked object. For example, the device configuration 334 may include a battery size and/or a current battery level, an indication of whether a wall-plugged power source is available, and/or an indication of available processor resources, available memory resources (e.g., RAM), and/or available storage (e.g., disk) resources.

In some aspects, as described herein, the sensor selection and configuration component 320 may select, from the various sensors that are available in the sensor subsystem, a set of sensor modalities that includes one or more of the available sensors. For example, as described herein, the set of sensor modalities may be selected based on the sensor usability information provided by the sensor usability component 314 and the one or more KPI requirements 330 (e.g., accuracy requirements, power constraints, hardware requirements, or the like) that are based on the client requirements 332 and the device configuration 334. Accordingly, the selected set of sensor modalities may be input to the model selection component 340, which may select and optimize a pose tracking model based on the selected set of sensor modalities. Furthermore, in some aspects, the sensor selection and configuration component 320 may provide, to the model selection component 340, information that relates to the current context 316 and/or a set of model selection parameters such as a power specification (e.g., a constraint or requirement), an accuracy specification, or the like (e.g., any suitable combination of the KPI requirements 330 and/or the context 316, the client requirements 332, and the device configuration 334 that are used to determine the KPI requirements 330). Accordingly, the model selection component 340 may then select and optimize a pose tracking model that is best suited to the current pose estimation task based on the selected set of sensor modalities and the various other model selection parameters provided by the sensor selection and configuration component 320.

For example, in some aspects, the model selection component 340 may have access to various different pose tracking models, and may select a pose tracking model to be used for a current pose estimation task based on the various inputs provided by the sensor selection and configuration component 320. For example, the various pose tracking models may include a visual inertial odometry (VIO) pose tracking model, a learned inertial odometry (LIO) pose tracking model, a GNSS plus LIO (GLIO) pose tracking model, a high-accuracy pose tracking model, a low-power pose tracking model, one or more user activity recognition models, or the like. Furthermore, each pose tracking model may be associated with one or more model sub-types. For example, a pose tracking model may be associated with a sub-type that relies on machine learning only, a sub-type that relies on Kalman filter propagation only, and/or a sub-type that relies on a combination of machine learning and Kalman filter propagation. Furthermore, one or more pose tracking models may be associated with different measurement types, which may include real measurements (e.g., camera measurements, GNSS measurements, pressure sensor measurements, or the like) and/or virtual measurements. For example, the virtual measurements may include motion-based or physics-based measurements (e.g., zero velocity updates, absolute stationary detection, and/or non-holonomic constraints) and/or learning-based measurements (e.g., multi-rate or single-rate LIO).

Accordingly, the model selection component 340 may then select and optimize a pose tracking model that is best suited to the current pose estimation task based on the selected set of sensor modalities and the various other model selection parameters provided by the sensor selection and configuration component 320. For example, in a scenario where the client requirements 332 indicate that a client application is requesting high-accuracy pose tracking and the device configuration 334 indicates that a battery is at or near full capacity, the model selection component 340 may select a high-accuracy pose tracking model (e.g., VIO) based on the selected set of sensor modalities indicating that a camera and GNSS receiver are usable in the current context 316. In another example, the client requirements 332 may indicate that power-efficient pose tracking is requested and the device configuration 334 may indicate that a battery level is limited (e.g., below a threshold), and the model selection component 340 may select a low-power pose tracking model that offers reasonable accuracy (e.g., an inertial odometry model, an inertial navigation model, a tight multi-rate LIO model, or the like).

In another example, the model selection component 340 may select a VIO model in a scenario where the selected sensor modalities include a camera, an accelerometer, and a gyroscope, the device configuration 334 indicates that power availability is high, the client requirements 332 indicate a high accuracy requirement, and the context 316 indicates that an XR headset is being used in a bright room with a large number of visual features. In another example, the model selection component 340 may select a GLIO model in a scenario where the selected sensor modalities include a GNSS receiver, an accelerometer, and a gyroscope, the device configuration 334 indicates that power availability is high, and the client requirements 332 indicate a high accuracy requirement. In still another example, the model selection component 340 may select a LIO model in a scenario where the selected sensor modalities include an accelerometer and a gyroscope (e.g., a GNSS receiver is unavailable), the device configuration 334 indicates that power availability is low, and the client requirements 332 indicate a moderate accuracy requirement.

In some aspects, in addition to selecting the pose tracking model that is best suited to a current pose estimation task based on the selected set of sensor modalities, the current context, and the KPI requirements 330 that are based on the client requirements 332 and the device configuration 334, the model selection component 340 may include a model optimizer that is used to configure the pose tracking model and continually rebalance tradeoffs associated with the client requirements 332, the device configuration 334, and the model feedback 370. In this way, the model selection component 340 may use the model optimizer to output an optimized pose tracking model (e.g., to the pose estimation component) for a given set of KPI requirements 330, context 316, and/or selected sensor modalities. For example, in some aspects, the model optimizer may be configured to perform one or more hardware optimizations for the selected pose tracking model (e.g., selecting a low-power island for low-power models or a CPU or GPU for high-power models, depending on availability). Additionally, or alternatively, the model optimizer may perform one or more software optimizations for the selected pose tracking model (e.g., quantization, neural network pruning, and/or data compression). Additionally, or alternatively, the model optimizer may perform one or more reconfiguration optimizations for the selected pose tracking model based on the model feedback 370 (e.g., using the model feedback 370 to tune the pose tracking model and/or reconfigure one or more associated parameters).

Accordingly, as described herein, the model selection component 340 may use the model optimizer to perform one or more hardware optimizations, one or more software optimizations, and/or one or more feedback-based optimizations on a pose tracking model that is selected for a given pose tracking task. For example, in a scenario where the pose tracking device is included in augmented reality (AR) glasses that a user is wearing while walking outdoors and the user walks into an indoor area, or where the pose tracking device is included in a vehicle that is driven into a tunnel or parking garage, the pose tracking device on the AR glasses may reconfigure one or more parameters of a selected pose tracking model to reduce dependence on GNSS signals and increase weights applied to sensor inputs associated with a camera. In another example, where the pose tracking device is included in a plugged-in device that has a high battery level and an available GPU, the model optimizer may perform a hardware optimization to choose the GPU as a preferred hardware resource based on a client application requesting a high-performance pose estimate. In another example, where the pose tracking device is included in a wearable device that has a low battery level and an available low-power island, the model optimizer may perform a hardware optimization to use the low-power island as a preferred hardware resource based on a client application weighting a continuous model output higher than performance accuracy. Additionally, or alternatively, the model optimizer may perform one or more software optimizations, such as machine learning model pruning, quantization, data compression, and/or data transfer optimizations to conserve computing resources and/or power. In other examples, the model optimizer may shift a processing and/or data burden from high-power hardware (e.g., a GPU) to low-power hardware (e.g., a low-power island or CPU) based on the model feedback 370 and/or a change in the client requirements 332, device configuration 334, and/or context 316 (e.g., where the model feedback 370 indicates that the selected pose tracking model is consuming more power than allowed for by the client requirements 332 and/or based on a change in the client requirements 332 that reduces a priority of the pose tracking).

In some aspects, as shown in FIG. 3, the pose tracking model that is selected and optimized by the model selection component may be provided to a pose estimation component 350, which may use the pose tracking model to generate a model output 360 based on a set of sensor inputs generated by the selected set of sensor modalities. For example, in some aspects, the model output 360 may include an estimated pose associated with a tracked object (e.g., a user, a user device, or another physical object), where the estimated pose may include an estimated position and/or an estimated orientation of the tracked object with respect to one or more axes. For example, in some aspects, the estimated position of the tracked object may include an absolute position of the tracked object on one or more axes at a specific time and/or a relative position (e.g., displacement) of the tracked object on one or more axes over a given time duration. Similarly, the estimated orientation of the tracked object may include an absolute orientation of the tracked object on one or more axes at a specific time and/or a relative orientation (e.g., a change in orientation) of the tracked object on one or more axes over a given time duration. Additionally, or alternatively, the model output 360 may include one or more parameters related to a motion state of the tracked object, such as a linear velocity estimate (e.g., an absolute and/or relative linear velocity estimate) and/or an angular velocity estimate (e.g., an absolute and/or relative angular velocity estimate). Additionally, or alternatively, the model output 360 may include one or more parameter calibrations, such as one or more sensor biases, sensor sensitivities, drift over time or temperature, or other suitable parameter calibrations.

In some aspects, as further shown in FIG. 3, the pose estimation component 350 may generate the model feedback 370 that may be continuously monitored and used to improve performance of various other components of the pose tracking device. For example, as shown in FIG. 3, the model feedback may be provided to the sensor usability component 314, the sensor selection and configuration component 320, and/or the model selection component 340. Furthermore, in some aspects, the model feedback 370 may be used to update the context 316 that is input to the sensor usability component 314, input to the sensor selection and configuration component 320, used to determine the one or more client requirements 332, and/or used to generate user feedback 380 (e.g., requesting that the user reset the pose tracking device or manually calibrate one or more sensors). For example, in some aspects, the model feedback 370 may include information such as an estimated confidence or uncertainty associated with the model output 360, a performance trend or saturation trend (e.g., Kalman filter innovation, loop closure, outlier rejection, or the like), a need for additional or specific sensor modalities, and/or power consumption metrics, among other examples.

Accordingly, as described herein, the model feedback 370 may be used in various ways to improve performance of various other components of the pose tracking device. For example, the model feedback 370 provided to the sensor selection and configuration component 320 may include performance metrics and power consumption metrics associated with the current pose tracking model, which the sensor selection and configuration component 320 may match against the client requirements 332. For example, in a scenario where the model feedback 370 indicates that performance for a current inertial measurement unit (IMU)-only pose tracking model has saturated with power consumption that is below a limit and an accuracy that does not satisfy the client requirements 332, the sensor modalities selected by the sensor selection and configuration component 320 may include one or more additional sensor modalities based on the current context 316. For example, the additional sensor modalities may include a GNSS based on the context 316 indicating that the user is biking outdoors with the pose tracking device included in a smartphone in the user's pocket, or a camera based on the context 316 indicating that the user is walking indoors on a flat surface with the pose tracking device included in a smartphone in the user's hand with a camera-facing motion detection. Furthermore, in such cases, other available sensors may remain disabled. In general, a process to update the selected sensor modalities may be initiated by the sensor selection and configuration component 320, and the sensor selection and configuration component 320 may decide when and/or whether to request new sensor modalities or invoke the sensor scan component 312 or the sensor usability component 314. Furthermore, the sensor selection and configuration component 320 may select an appropriate configuration for each sensor modality that is selected for a given pose estimation task (e.g., an IMU sampling frequency and/or a camera frame rate, among other examples).

Accordingly, as described herein, the model feedback 370 may be used by the sensor selection and configuration component 320 to determine whether to add and/or remove one or more sensor modalities (e.g., based on an estimated uncertainty or performance trend associated with the model output 360, which may indicate the effectiveness or trustworthiness of the currently selected sensor modalities). Furthermore, the model feedback 370 may be used to improve performance of the model selection component 340. For example, the model feedback 370 may include performance metrics and/or power consumption metrics, which the model selection component 340 may use to determine when and/or whether there is a need to tune or reconfigure a pose tracking model (e.g., based on an estimated uncertainty or performance trend that indicates the effectiveness of the current pose tracking model). Additionally, or alternatively, the model feedback 370 may be used to generate the user feedback 380, which may include one or more outputs in which the user is requested to intervene to improve performance of the pose tracking device. For example, in some aspects, the user feedback 380 may include a request that the user manually recalibrate a magnetometer (e.g., by performing a figure-8 movement with the pose tracking device that includes the magnetometer), change environmental conditions (e.g., to move to a different location when model uncertainty is too high), charge a battery when the battery level fails to satisfy a threshold or to replace the battery when the battery consistently fails to hold a charge, and/or to provide permissions to enable location tracking, a Wi-Fi or WLAN radio, and/or a cellular radio. For example, in some aspects, the user feedback 380 may request that the user provide permission to share one or more information or data items related to the user in order to protect a privacy of the user.

In this way, the model feedback 370 may be used in various ways to improve overall performance of the pose tracking device. For example, in some aspects, the model feedback 370 may be used to update one or more decision policies that are used by the sensor selection and configuration component 320 to select the set of sensor modalities, or by the model selection component 340 to select the current pose tracking model. Additionally, or alternatively, the model feedback 370 may be used to generate the user feedback 380 in which the user is requested to intervene to calibrate one or more decision policies that are used to select the sensor modalities and/or the current pose tracking model. Furthermore, the model feedback 370 may be used to update a context used to select the sensor modalities and/or the current pose tracking model. For example, a user activity recognition algorithm may face difficulty distinguishing between motion on a car versus a train, and the model feedback 370 could be used (e.g., as velocity over a certain duration) as an additional input to update the user activity recognition state or vehicle classification state associated with the current context 316. Additionally, or alternatively, the model feedback 370 may be shared with one or more external devices (e.g., other devices associated with the same user or different original equipment manufacturer (OEM) devices with the same form factor and/or following a common KPI protocol or the Internet cloud).

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

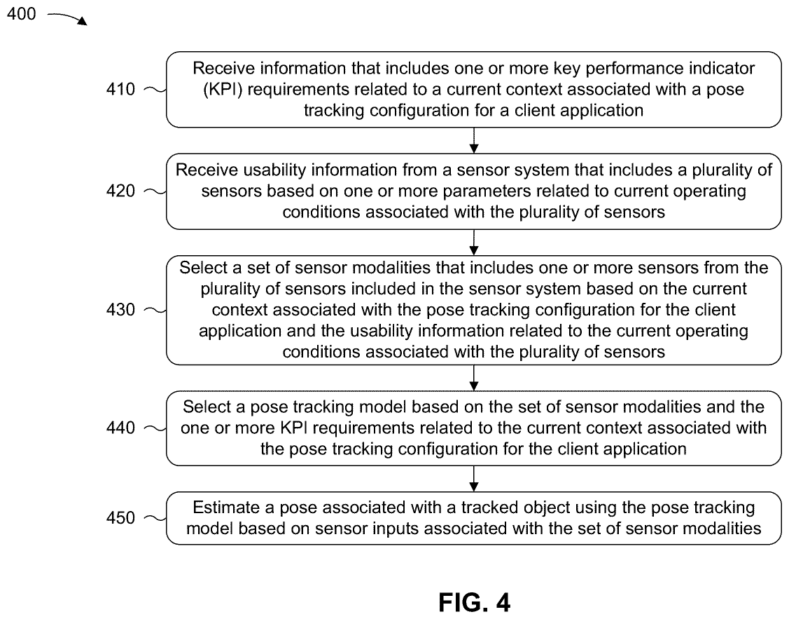

FIG. 4 is a flowchart of an example process 400 associated with power-efficient, performance-efficient, and context-adaptive pose tracking, in accordance with the present disclosure. In some aspects, one or more process blocks of FIG. 4 are performed by a pose tracking device (e.g., pose tracking device 110). In some aspects, one or more process blocks of FIG. 4 are performed by another device or a group of devices separate from or including the pose tracking device, such as a tracked object (e.g., tracked object 120) and/or a network node (e.g., network node 130). Additionally, or alternatively, one or more process blocks of FIG. 4 may be performed by one or more components of device 200, such as processor 210, memory 215, storage component 220, input component 225, output component 230, communication interface 235, sensor subsystem 240, and/or pose tracking component 245.

As shown in FIG. 4, process 400 may include receiving information that includes one or more KPI requirements related to a current context associated with a pose tracking configuration for a client application (block 410). For example, the pose tracking device may receive information that includes one or more KPI requirements related to a current context associated with a pose tracking configuration for a client application, as described above.

As further shown in FIG. 4, process 400 may include receiving usability information from a sensor system that includes a plurality of sensors based on one or more parameters related to current operating conditions associated with the plurality of sensors (block 420). For example, the pose tracking device may receive usability information from a sensor system that includes a plurality of sensors based on one or more parameters related to current operating conditions associated with the plurality of sensors, as described above.

As further shown in FIG. 4, process 400 may include selecting a set of sensor modalities that includes one or more sensors from the plurality of sensors included in the sensor system based on the current context associated with the pose tracking configuration for the client application and the usability information related to the current operating conditions associated with the plurality of sensors (block 430). For example, the pose tracking device may select a set of sensor modalities that includes one or more sensors from the plurality of sensors included in the sensor system based on the current context associated with the pose tracking configuration for the client application and the usability information related to the current operating conditions associated with the plurality of sensors, as described above.

As further shown in FIG. 4, process 400 may include selecting a pose tracking model based on the set of sensor modalities and the one or more KPI requirements related to the current context associated with the pose tracking configuration for the client application (block 440). For example, the pose tracking device may select a pose tracking model based on the set of sensor modalities and the one or more KPI requirements related to the current context associated with the pose tracking configuration for the client application, as described above.

As further shown in FIG. 4, process 400 may include estimating a pose associated with a tracked object using the pose tracking model based on sensor inputs associated with the set of sensor modalities (block 450). For example, the pose tracking device may estimate a pose associated with a tracked object using the pose tracking model based on sensor inputs associated with the set of sensor modalities, as described above.

Process 400 may include additional aspects, such as any single aspect or any combination of aspects described below and/or in connection with one or more other processes described elsewhere herein.

In a first aspect, the usability information includes, for each sensor of the plurality of sensors included in the sensor system, a respective usability score that is based on a context that includes one or more of a device type, a motion state, a current user activity state, a device placement state, or a device location state associated with the sensor.

In a second aspect, alone or in combination with the first aspect, the pose tracking model is selected based on a set of inputs that include one or more of selected sensor modalities, available hardware resources associated with the pose tracking device, an accuracy requirement for estimating the pose, the context, or the one or more KPI requirements.

In a third aspect, alone or in combination with one or more of the first and second aspects, the one or more KPI requirements related to the current context associated with the pose tracking configuration include one or more parameters related to a power consumption requirement for estimating the pose.

In a fourth aspect, alone or in combination with one or more of the first through third aspects, the one or more KPI requirements related to the current context associated with the pose tracking configuration include one or more parameters related to an accuracy requirement for estimating the pose.

In a fifth aspect, alone or in combination with one or more of the first through fourth aspects, the one or more KPI requirements are based on a context that includes one or more of a device type, a motion state, a current user activity state, a device placement state, or a device location state associated with the sensor.

In a sixth aspect, alone or in combination with one or more of the first through fifth aspects, the estimated pose relates to one or more of a position of the tracked object with respect to one or more axes or an orientation of the tracked object with respect to one or more axes.

In a seventh aspect, alone or in combination with one or more of the first through sixth aspects, the position of the tracked object includes an absolute position at a specific time instance or a relative position or displacement over a specified time duration.

In an eighth aspect, alone or in combination with one or more of the first through seventh aspects, the orientation of the tracked object includes an absolute orientation at a specific time instance or a relative orientation or change in orientation over a specified time duration.

In a ninth aspect, alone or in combination with one or more of the first through eighth aspects, process 400 includes estimating one or more velocities associated with the tracked object or one or more parameters to calibrate the one or more sensors using the pose tracking model and the sensor inputs associated with the set of sensor modalities.

In a tenth aspect, alone or in combination with one or more of the first through ninth aspects, process 400 includes generating feedback that relates to performance of the pose tracking model in estimating the pose associated with the tracked object, and updating one or more decision policies that are used to select at least one of the set of sensor modalities or the pose tracking model based on the feedback.

In an eleventh aspect, alone or in combination with one or more of the first through tenth aspects, process 400 includes generating feedback that relates to performance of the pose tracking model in estimating the pose associated with the tracked object, and generating one or more outputs to request one or more user interactions to calibrate one or more decision policies that are used to select at least one of the set of sensor modalities or the pose tracking model based on the feedback.

In a twelfth aspect, alone or in combination with one or more of the first through eleventh aspects, process 400 includes generating feedback that relates to performance of the pose tracking model in estimating the pose associated with the tracked object, and sharing the feedback that relates to the performance of the pose tracking model with one or more external devices.

In a thirteenth aspect, alone or in combination with one or more of the first through twelfth aspects, process 400 includes generating feedback that relates to performance of the pose tracking model in estimating the pose associated with the tracked object, and updating a context used to select at least one of the set of sensor modalities or the pose tracking model based on the feedback.

Although FIG. 4 shows example blocks of process 400, in some aspects, process 400 includes additional blocks, fewer blocks, different blocks, or differently arranged blocks than those depicted in FIG. 4. Additionally, or alternatively, two or more of the blocks of process 400 may be performed in parallel.

The following provides an overview of some Aspects of the present disclosure:

Aspect 1: A method for power-efficient and performance-efficient context-adaptive pose tracking, comprising: receiving, by a pose tracking device, information that includes one or more KPI requirements related to a current context associated with a pose tracking configuration for a client application; receiving, by the pose tracking device, usability information from a sensor system that includes a plurality of sensors based on one or more parameters related to current operating conditions associated with the plurality of sensors; selecting, by the pose tracking device, a set of sensor modalities that includes one or more sensors from the plurality of sensors included in the sensor system based on the current context associated with the pose tracking configuration for the client application and the usability information related to the current operating conditions associated with the plurality of sensors; selecting, by the pose tracking device, a pose tracking model based on the set of sensor modalities and the one or more KPI requirements related to the current context associated with the pose tracking configuration for the client application; and estimating, by the pose tracking device, a pose associated with a tracked object using the pose tracking model based on sensor inputs associated with the set of sensor modalities.

Aspect 2: The method of Aspect 1, wherein the usability information includes, for each sensor of the plurality of sensors included in the sensor system, a respective usability score that is based on a context that includes one or more of a device type, a motion state, a current user activity state, a device placement state, or a device location state associated with the sensor.

Aspect 3: The method of any of Aspects 1-2, wherein the pose tracking model is selected based on a set of inputs that include one or more of selected sensor modalities, available hardware resources associated with the pose tracking device, an accuracy requirement for estimating the pose, the context, or the one or more KPI requirements.

Aspect 4: The method of any of Aspects 1-3, wherein the one or more KPI requirements related to the current context associated with the pose tracking configuration include one or more parameters related to a power consumption requirement for estimating the pose.

Aspect 5: The method of any of Aspects 1-4, wherein the one or more KPI requirements related to the current context associated with the pose tracking configuration include one or more parameters related to an accuracy requirement for estimating the pose.

Aspect 6: The method of any of Aspects 1-5, wherein the one or more KPI requirements are based on a context that includes one or more of a device type, a motion state, a current user activity state, a device placement state, or a device location state associated with the sensor.

Aspect 7: The method of any of Aspects 1-6, wherein the estimated pose relates to one or more of a position of the tracked object with respect to one or more axes or an orientation of the tracked object with respect to one or more axes.

Aspect 8: The method of Aspect 6, wherein the position of the tracked object includes an absolute position at a specific time instance or a relative position or displacement over a specified time duration.

Aspect 9: The method of Aspect 6, wherein the orientation of the tracked object includes an absolute orientation at a specific time instance or a relative orientation or change in orientation over a specified time duration.

Aspect 10: The method of any of Aspects 1-9, further comprising: estimating one or more velocities associated with the tracked object or one or more parameters to calibrate the one or more sensors using the pose tracking model and the sensor inputs associated with the set of sensor modalities.

Aspect 11: The method of any of Aspects 1-10, further comprising: generating feedback that relates to performance of the pose tracking model in estimating the pose associated with the tracked object; and updating one or more decision policies that are used to select at least one of the set of sensor modalities or the pose tracking model based on the feedback.

Aspect 12: The method of any of Aspects 1-11, further comprising: generating feedback that relates to performance of the pose tracking model in estimating the pose associated with the tracked object; and generating one or more outputs to request one or more user interactions to calibrate one or more decision policies that are used to select at least one of the set of sensor modalities or the pose tracking model based on the feedback.

Aspect 13: The method of any of Aspects 1-12, further comprising: generating feedback that relates to performance of the pose tracking model in estimating the pose associated with the tracked object; and sharing the feedback that relates to the performance of the pose tracking model with one or more external devices.

Aspect 14: The method of any of Aspects 1-13, further comprising: generating feedback that relates to performance of the pose tracking model in estimating the pose associated with the tracked object; and updating a context used to select at least one of the set of sensor modalities or the pose tracking model based on the feedback.

Aspect 15: A pose tracking device for power-efficient and performance-efficient context-adaptive pose tracking, comprising: one or more memories; and one or more processors, coupled to the one or more memories, configured to: receive information that includes one or more KPI requirements related to a current context associated with a pose tracking configuration for a client application; receive usability information from a sensor system that includes a plurality of sensors based on one or more parameters related to current operating conditions associated with the plurality of sensors; select a set of sensor modalities that includes one or more sensors from the plurality of sensors included in the sensor system based on the current context associated with the pose tracking configuration for the client application and the usability information related to the current operating conditions associated with the plurality of sensors; select a pose tracking model based on the set of sensor modalities and the one or more KPI requirements related to the current context associated with the pose tracking configuration for the client application; and estimate a pose associated with a tracked object using the pose tracking model based on sensor inputs associated with the set of sensor modalities.

Aspect 16: The pose tracking device of Aspect 15, wherein the usability information includes, for each sensor of the plurality of sensors included in the sensor system, a respective usability score that is based on a context that includes one or more of a device type, a motion state, a current user activity state, a device placement state, or a device location state associated with the sensor.

Aspect 17: The pose tracking device of any of Aspects 15-16, wherein the pose tracking model is selected based on a set of inputs that include one or more of selected sensor modalities, available hardware resources associated with the pose tracking device, an accuracy requirement for estimating the pose, the context, or the one or more KPI requirements.

Aspect 18: The pose tracking device of any of Aspects 15-17, wherein the one or more KPI requirements related to the current context associated with the pose tracking configuration include one or more parameters related to a power consumption requirement for estimating the pose.

Aspect 19: The pose tracking device of any of Aspects 15-18, wherein the one or more KPI requirements related to the current context associated with the pose tracking configuration include one or more parameters related to an accuracy requirement for estimating the pose.

Aspect 20: The pose tracking device of any of Aspects 15-19, wherein the one or more KPI requirements are based on a context that includes one or more of a device type, a motion state, a current user activity state, a device placement state, or a device location state associated with the sensor.

Aspect 21: The pose tracking device of any of Aspects 15-20, wherein the estimated pose relates to one or more of a position of the tracked object with respect to one or more axes or an orientation of the tracked object with respect to one or more axes.

Aspect 22: The pose tracking device of Aspect 20, wherein the position of the tracked object includes an absolute position at a specific time instance or a relative position or displacement over a specified time duration.

Aspect 23: The pose tracking device of Aspect 20, wherein the orientation of the tracked object includes an absolute orientation at a specific time instance or a relative orientation or change in orientation over a specified time duration.

Aspect 24: The pose tracking device of any of Aspects 15-23, wherein the one or more processors are further configured to: estimate one or more velocities associated with the tracked object or one or more parameters to calibrate the one or more sensors using the pose tracking model and the sensor inputs associated with the set of sensor modalities.

Aspect 25: The pose tracking device of any of Aspects 15-24, wherein the one or more processors are further configured to: generate feedback that relates to performance of the pose tracking model in estimating the pose associated with the tracked object; and update one or more decision policies that are used to select at least one of the set of sensor modalities or the pose tracking model based on the feedback.

Aspect 26: The pose tracking device of any of Aspects 15-25, wherein the one or more processors are further configured to: generate feedback that relates to performance of the pose tracking model in estimating the pose associated with the tracked object; and generate one or more outputs to request one or more user interactions to calibrate one or more decision policies that are used to select at least one of the set of sensor modalities or the pose tracking model based on the feedback.

Aspect 27: The pose tracking device of any of Aspects 15-26, wherein the one or more processors are further configured to: generate feedback that relates to performance of the pose tracking model in estimating the pose associated with the tracked object; and share the feedback that relates to the performance of the pose tracking model with one or more external devices.

Aspect 28: The pose tracking device of any of Aspects 15-27, wherein the one or more processors are further configured to: generate feedback that relates to performance of the pose tracking model in estimating the pose associated with the tracked object; and update a context used to select at least one of the set of sensor modalities or the pose tracking model based on the feedback.

Aspect 29: A non-transitory computer-readable medium storing a set of instructions for power-efficient and performance-efficient context-adaptive pose tracking, the set of instructions comprising: one or more instructions that, when executed by one or more processors of a pose tracking device, cause the pose tracking device to: receive information that includes one or more KPI requirements related to a current context associated with a pose tracking configuration for a client application; receive usability information from a sensor system that includes a plurality of sensors based on one or more parameters related to current operating conditions associated with the plurality of sensors; select a set of sensor modalities that includes one or more sensors from the plurality of sensors included in the sensor system based on the current context associated with the pose tracking configuration for the client application and the usability information related to the current operating conditions associated with the plurality of sensors; select a pose tracking model based on the set of sensor modalities and the one or more KPI requirements related to the current context associated with the pose tracking configuration for the client application; and estimate a pose associated with a tracked object using the pose tracking model based on sensor inputs associated with the set of sensor modalities.

Aspect 30: An apparatus for power-efficient and performance-efficient context-adaptive pose tracking, comprising: means for receiving information that includes one or more KPI requirements related to a current context associated with a pose tracking configuration for a client application; means for receiving usability information from a sensor system that includes a plurality of sensors based on one or more parameters related to current operating conditions associated with the plurality of sensors; means for selecting a set of sensor modalities that includes one or more sensors from the plurality of sensors included in the sensor system based on the current context associated with the pose tracking configuration for the client application and the usability information related to the current operating conditions associated with the plurality of sensors; means for selecting a pose tracking model based on the set of sensor modalities and the one or more KPI requirements related to the current context associated with the pose tracking configuration for the client application; and means for estimating a pose associated with a tracked object using the pose tracking model based on sensor inputs associated with the set of sensor modalities.

Aspect 31: A system configured to perform one or more operations recited in one or more of Aspects 1-30.

Aspect 32: An apparatus comprising means for performing one or more operations recited in one or more of Aspects 1-30.

Aspect 33: A non-transitory computer-readable medium storing a set of instructions, the set of instructions comprising one or more instructions that, when executed by a device, cause the device to perform one or more operations recited in one or more of Aspects 1-30.

Aspect 34: A computer program product comprising instructions or code for executing one or more operations recited in one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method for power-efficient and performance-efficient context-adaptive pose tracking, comprising:
receiving, by a pose tracking device, information that includes one or more key performance indicator (KPI) requirements related to a current context associated with a pose tracking configuration for a client application;
receiving, by the pose tracking device, usability information from a sensor system that includes a plurality of sensors based on one or more parameters related to current operating conditions associated with the plurality of sensors;
selecting, by the pose tracking device, a set of sensor modalities that includes one or more sensors from the plurality of sensors included in the sensor system based on the current context associated with the pose tracking configuration for the client application and the usability information related to the current operating conditions associated with the plurality of sensors;
selecting, by the pose tracking device, a pose tracking model based on the set of sensor modalities and the one or more KPI requirements related to the current context associated with the pose tracking configuration for the client application; and
estimating, by the pose tracking device, a pose associated with a tracked object using the pose tracking model based on sensor inputs associated with the set of sensor modalities.

2. The method of claim 1, wherein the usability information includes, for each sensor of the plurality of sensors included in the sensor system, a respective usability score that is based on a context that includes one or more of a device type, a motion state, a current user activity state, a device placement state, or a device location state associated with the sensor.

3. The method of claim 1, wherein the pose tracking model is selected based on a set of inputs that include one or more of selected sensor modalities, available hardware resources associated with the pose tracking device, an accuracy requirement for estimating the pose, the context, or the one or more KPI requirements.

4. The method of claim 1, wherein the one or more KPI requirements related to the current context associated with the pose tracking configuration include one or more parameters related to a power consumption requirement for estimating the pose.

5. The method of claim 1, wherein the one or more KPI requirements related to the current context associated with the pose tracking configuration include one or more parameters related to an accuracy requirement for estimating the pose.

6. The method of claim 1, wherein the one or more KPI requirements are based on a context that includes one or more of a device type, a motion state, a current user activity state, a device placement state, or a device location state associated with the sensor.

7. The method of claim 1, wherein the estimated pose relates to one or more of a position of the tracked object with respect to one or more axes or an orientation of the tracked object with respect to one or more axes.

8. The method of claim 7, wherein the position of the tracked object includes an absolute position at a specific time instance or a relative position or displacement over a specified time duration.

9. The method of claim 7, wherein the orientation of the tracked object includes an absolute orientation at a specific time instance or a relative orientation or change in orientation over a specified time duration.

10. The method of claim 1, further comprising:
estimating one or more velocities associated with the tracked object or one or more parameters to calibrate the one or more sensors using the pose tracking model and the sensor inputs associated with the set of sensor modalities.

11. The method of claim 1, further comprising:
generating feedback that relates to performance of the pose tracking model in estimating the pose associated with the tracked object; and
updating one or more decision policies that are used to select at least one of the set of sensor modalities or the pose tracking model based on the feedback.

12. The method of claim 1, further comprising:
generating feedback that relates to performance of the pose tracking model in estimating the pose associated with the tracked object; and
generating one or more outputs to request one or more user interactions to calibrate one or more decision policies that are used to select at least one of the set of sensor modalities or the pose tracking model based on the feedback.

13. The method of claim 1, further comprising:
generating feedback that relates to performance of the pose tracking model in estimating the pose associated with the tracked object; and
sharing the feedback that relates to the performance of the pose tracking model with one or more external devices.

14. The method of claim 1, further comprising:
generating feedback that relates to performance of the pose tracking model in estimating the pose associated with the tracked object; and
updating a context used to select at least one of the set of sensor modalities or the pose tracking model based on the feedback.

15. A pose tracking device for power-efficient and performance-efficient context-adaptive pose tracking, comprising:
one or more memories; and
one or more processors, coupled to the one or more memories, configured to:
receive information that includes one or more key performance indicator (KPI) requirements related to a current context associated with a pose tracking configuration for a client application;
receive usability information from a sensor system that includes a plurality of sensors based on one or more parameters related to current operating conditions associated with the plurality of sensors;
select a set of sensor modalities that includes one or more sensors from the plurality of sensors included in the sensor system based on the current context associated with the pose tracking configuration for the client application and the usability information related to the current operating conditions associated with the plurality of sensors;
select a pose tracking model based on the set of sensor modalities and the one or more KPI requirements related to the current context associated with the pose tracking configuration for the client application; and
estimate a pose associated with a tracked object using the pose tracking model based on sensor inputs associated with the set of sensor modalities.

16. The pose tracking device of claim 15, wherein the usability information includes, for each sensor of the plurality of sensors included in the sensor system, a respective usability score that is based on a context that includes one or more of a device type, a motion state, a current user activity state, a device placement state, or a device location state associated with the sensor.

17. The pose tracking device of claim 15, wherein the pose tracking model is selected based on a set of inputs that include one or more of selected sensor modalities, available hardware resources associated with the pose tracking device, an accuracy requirement for estimating the pose, the context, or the one or more KPI requirements.

18. The pose tracking device of claim 15, wherein the one or more KPI requirements related to the current context associated with the pose tracking configuration include one or more parameters related to a power consumption requirement for estimating the pose.

19. The pose tracking device of claim 15, wherein the one or more KPI requirements related to the current context associated with the pose tracking configuration include one or more parameters related to an accuracy requirement for estimating the pose.

20. The pose tracking device of claim 15, wherein the one or more KPI requirements are based on a context that includes one or more of a device type, a motion state, a current user activity, a device placement state, or a device state location associated with the sensor.

21. The pose tracking device of claim 15, wherein the estimated pose relates to one or more of a position of the tracked object with respect to one or more axes or an orientation of the tracked object with respect to one or more axes.

22. The pose tracking device of claim 21, wherein the position of the tracked object includes an absolute position at a specific time instance or a relative position or displacement over a specified time duration.

23. The pose tracking device of claim 21, wherein the orientation of the tracked object includes an absolute orientation at a specific time instance or a relative orientation or change in orientation over a specified time duration.

24. The pose tracking device of claim 15, wherein the one or more processors are further configured to:
estimate one or more velocities associated with the tracked object or one or more parameters to calibrate the one or more sensors using the pose tracking model and the sensor inputs associated with the set of sensor modalities.

25. The pose tracking device of claim 15, wherein the one or more processors are further configured to:
generate feedback that relates to performance of the pose tracking model in estimating the pose associated with the tracked object; and
update one or more decision policies that are used to select at least one of the set of sensor modalities or the pose tracking model based on the feedback.

26. The pose tracking device of claim 15, wherein the one or more processors are further configured to:
generate feedback that relates to performance of the pose tracking model in estimating the pose associated with the tracked object; and
generate one or more outputs to request one or more user interactions to calibrate one or more decision policies that are used to select at least one of the set of sensor modalities or the pose tracking model based on the feedback.

27. The pose tracking device of claim 15, wherein the one or more processors are further configured to:
generate feedback that relates to performance of the pose tracking model in estimating the pose associated with the tracked object; and
share the feedback that relates to the performance of the pose tracking model with one or more external devices.

28. The pose tracking device of claim 15, wherein the one or more processors are further configured to:
generate feedback that relates to performance of the pose tracking model in estimating the pose associated with the tracked object; and
update a context used to select at least one of the set of sensor modalities or the pose tracking model based on the feedback.

29. A non-transitory computer-readable medium storing a set of instructions for power-efficient and performance-efficient context-adaptive pose tracking, the set of instructions comprising:
one or more instructions that, when executed by one or more processors of a pose tracking device, cause the pose tracking device to:
receive information that includes one or more key performance indicator (KPI) requirements related to a current context associated with a pose tracking configuration for a client application;
receive usability information from a sensor system that includes a plurality of sensors based on one or more parameters related to current operating conditions associated with the plurality of sensors;
select a set of sensor modalities that includes one or more sensors from the plurality of sensors included in the sensor system based on the current context associated with the pose tracking configuration for the client application and the usability information related to the current operating conditions associated with the plurality of sensors;
select a pose tracking model based on the set of sensor modalities and the one or more KPI requirements related to the current context associated with the pose tracking configuration for the client application; and
estimate a pose associated with a tracked object using the pose tracking model based on sensor inputs associated with the set of sensor modalities.

30. An apparatus for power-efficient and performance-efficient context-adaptive pose tracking, comprising:
means for receiving information that includes one or more key performance indicator (KPI) requirements related to a current context associated with a pose tracking configuration for a client application;
means for receiving usability information from a sensor system that includes a plurality of sensors based on one or more parameters related to current operating conditions associated with the plurality of sensors;
means for selecting a set of sensor modalities that includes one or more sensors from the plurality of sensors included in the sensor system based on the current context associated with the pose tracking configuration for the client application and the usability information related to the current operating conditions associated with the plurality of sensors;
means for selecting a pose tracking model based on the set of sensor modalities and the one or more KPI requirements related to the current context associated with the pose tracking configuration for the client application; and
means for estimating a pose associated with a tracked object using the pose tracking model based on sensor inputs associated with the set of sensor modalities.
